(19) United States
(12) Patent Application Publication
(10) Pub. No.: US 2026/0192604 A1
(43) Pub. Date: Jul. 9, 2026

(54) PNEUMATIC TIRE

(71) Applicant: Toyo Tire Corporation, Itami-shi (JP)

(72) Inventor: Shota YANAHARA, Itami-shi (JP)

(21) Appl. No.: 19/440,258

(22) Filed: Jan. 5, 2026

(30) Foreign Application Priority Data
Jan. 8, 2025 (JP) 2025-002831

(51) Int. Cl. B60C 11/12; B60C 11/03; B60C 11/04

(52) U.S. Cl. CPC B60C 11/1204; B60C 11/04; B60C 2011/0353; B60C 2011/0355; B60C 2011/1213

(57) ABSTRACT

A pneumatic tire comprising a tread is provided. The tread includes a center land portion, a middle land portion, and a shoulder land portion, and multiple sipes are formed in the center land portion, the middle land portion, and the shoulder land portion. When, in lengths of the sipes in a longitudinal direction, lengths of components along a tire axial direction are defined as sipe lateral lengths, a total value of the sipe lateral lengths of all the sipes in a ground contact surface of the tread divided by an area of the entire ground contact surface of the tread is a value of 0.050 m/mm² or more, and a rectangularity of the ground contact surface of the tread is between 0.60 and 0.70.

### CROSS REFERENCE TO RELATED APPLICATION

The full disclosure of Japanese Patent Application No. 2025-002831 filed on Jan. 8, 2025 including the specification, claims, drawings, and abstract is incorporated herein by reference in its entirety.

### TECHNICAL FIELD

The present disclosure relates to a pneumatic tire.

### BACKGROUND

Conventionally, a pneumatic tire is known that includes a tread having multiple main grooves extending along a tire circumferential direction, and multiple land portions partitioned by the main grooves (see, for example, JP 2014-73706 A). JP 2014-73706 A discloses that a tread ground contact surface is formed in a predetermined shape, while multiple sipes are provided in each land portion.

### SUMMARY

### Technical Problem

In recent years, there has been a demand for tires with superior noise performance. Reducing a groove volume of a main groove, a lateral groove, or the like provided in a tread can generally reduce noise during travel. However reducing the groove volume also affects snow column shear force for grasping and compacting snow, likely impairing steering stability when traveling on a snow-covered road surface (hereinafter referred to as “on-snow performance”). As such, there have been barriers to improving noise performance while also ensuring on-snow performance.

### Solution to Problem

A pneumatic tire according to an aspect of the present disclosure is a pneumatic tire comprising a tread, the tread including a pair of center main grooves, a pair of shoulder main grooves placed outward of the center main grooves in a tire axial direction, a center land portion partitioned by the pair of center main grooves, a middle land portion partitioned by each of the center main grooves and each of the shoulder main grooves, and a shoulder land portion placed outward of the shoulder main groove in the tire axial direction, wherein multiple sipes are formed in the center land portion, the middle land portion and the shoulder land portion and when, in lengths of the sipes in a longitudinal direction, lengths of components along the tire axial direction are defined as sipe lateral lengths, a total value of the sipe lateral lengths of all the sipes in a ground contact surface of the treads divided by an area of the entire ground contact surface of the tread is a value of 0.050 m/mm² or more; and a rectangularity of the ground contact surface of the tread is between 0.60 and 0.70.

### Advantageous Effects of Invention

According to a pneumatic tire that is an aspect of the present disclosure, noise performance can be improved while ensuring on-snow performance.

### BRIEF DESCRIPTION OF DRAWINGS

Embodiments of the present disclosure will be described based on the following figures, wherein:

FIG. 1 is a cross-sectional view of a pneumatic tire that is an example of an embodiment;

FIG. 2 is a plan view of a tread of the pneumatic tire that is the example of the embodiment;

FIG. 3 is a view schematically showing the shape of a ground contact surface of the tread; and

FIG. 4 is a plan view of the tread in a pneumatic tire of a comparative example.

### DESCRIPTION OF EMBODIMENTS

Hereinafter, an example embodiment of a pneumatic tire according to the present disclosure will be described in detail with reference to the drawings. The embodiment described below is merely an example, and the present disclosure is not limited to the following embodiment. Furthermore, the present disclosure includes forms comprising a selected combinations of respective components of the embodiment described below.

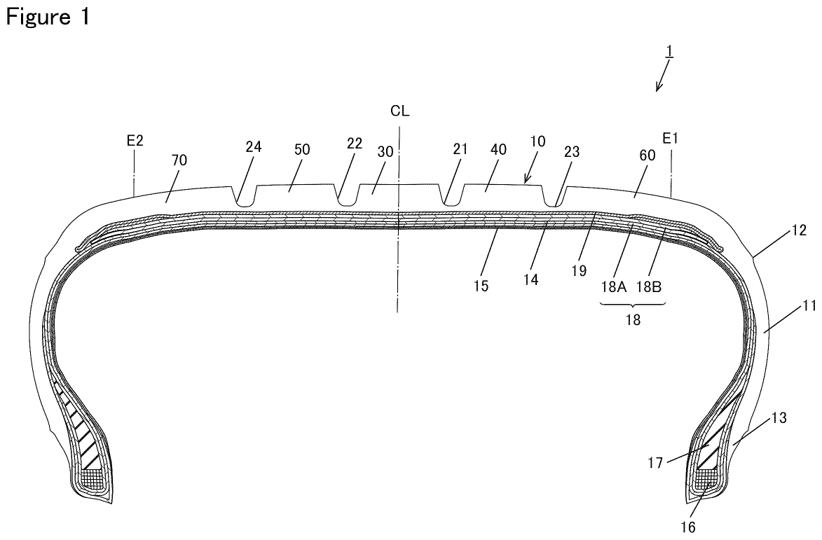

FIG. 1 is a cross-sectional view of a pneumatic tire 1 that is an example of the embodiment, also showing an internal structure of the tire. As shown in FIG. 1, the pneumatic tire 1 includes a tread 10 that is a portion in contact with a road surface, a pair of sidewalls 11 arranged on opposite sides of the tread 10, and a pair of beads 13 arranged inward of the sidewalls 11 in a tire radial direction. Furthermore, the pneumatic tire 1 further includes a carcass 14 extended between the pair of beads 13 and an inner liner 15 placed inward of the carcass 14 in the tire radial direction. The pneumatic tire 1 provides superior performance not only on a dry road surface, but also on wet or snowy and icy road surfaces, and is therefore suitable for use as an all-season tire.

In the present embodiment, the mounting direction of the pneumatic tire 1 to a vehicle is not limited, and the pneumatic tire is a point-symmetrical tire in which a tread pattern and the shape of a tire side surface remain unchanged regardless if the direction in which the tire is mounted to the vehicle. That is, the tread pattern and the shape of the tire side surface of the pneumatic tire 1 are formed in such a manner that they are rotated 180 degrees on either side of the tire equator CL. Here, the tire equator CL is a virtual line along a tire circumferential direction and passing through a middle portion of the tread 10 in the tire axial direction.

The tread 10 includes a pair of center main grooves 21 and 22 extending along the tire circumferential direction, and a pair of shoulder main grooves 23 and 24 provided outward of the center main grooves 21 and 22 in the tire axial direction, the shoulder main grooves extending along the tire circumferential direction. The four main grooves are formed straight along the tire circumferential direction, without bending in the tire axial direction.

Furthermore, the tread 10 includes a center land portion 30 partitioned by the pair of center main grooves 21 and 22 and formed on the tire equator CL, a first middle land portion 40 partitioned by the center main groove 21 and the shoulder main groove 23, and a second middle land portion 50 partitioned by the center main groove 22 and the shoulder main groove 24. Furthermore, the tread 10 includes a first shoulder land portion 60 placed opposite the first middle land portion 40 via the shoulder main groove 23 in the tire axial direction, and a second shoulder land portion 70 placed opposite the second middle land portion 50 via the shoulder main groove 24 in the tire axial direction. The first shoulder land portion 60 and the second shoulder land portion 70 are formed beyond ground contact ends E1 and E2. The land portion is a portion raised outward from a position corresponding to the bottom of the main groove in the tire radial direction.

Here, the ground contact ends E1 and E2 of the pneumatic tire 1 are defined as opposite ends of a region (ground contact surface) in contact with a flat road surface in the tire axial direction, when an unused tire is mounted on a specified rim and filled with air to reach a specified internal pressure and a predetermined load is applied. The predetermined load is a load that is 88% of a specified load.

It should be noted that as used herein “specified rim” refers to a rim defined by a tire standard, and specifically a “standard rim” defined by the Japan Automobile Tyre Manufacturers Association Inc. (JATMA) or a “measuring rim” defined by the Tire and Rim Association (TRA) and the European Tyre and Rim Technical Organization (ETRTO). Furthermore, the “specified internal pressure” refers to a “maximum air pressure” defined by JATMA, the maximum value in the table TIRE LOAD LIMITS AT VARIOUS COLD INFLATION PRESSURES defined by TRA, or to the “inflation pressure” defined by ETRTO. The specified internal pressure is typically 180 kPa for passenger car tires, and it is 220 kPa for tires labeled “Extra Load” or “Reinforced”. The “specified load” refers to a “maximum load capacity” defined by JATMA, the maximum value in the table TIRE LOAD LIMITS AT VARIOUS COLD INFLATION PRESSURES defined by TRA, or the “load capacity” defined by ETRTO.

As will be described later in detail, the ground contact surface of the tread 10 of the present embodiment has a comparatively short ground contact length in the vicinity of the ground contact ends E1 and E2 relative to a length (ground contact length) of the ground contact surface on the tire equator CL along the tire circumferential direction, and the shape of the ground contact surface of the tread 10 is close to an elliptical shape. Specifically, the tread 10 is designed so that the ground contact surface has a rectangularity of between 0.6 and 0.7.

The sidewalls 11 are arranged on opposite sides of the tread 10 and are provided in an annular shape along the tire circumferential direction. Each sidewall 11 is a portion that protrudes furthest outward in the tire axial direction in the pneumatic tire 1 and is gently curved to be convex toward an outer side in the tire axial direction. A function of the sidewall 11 is to prevent damage to the carcass 14. The sidewall 11 is the most deformable portion providing the pneumatic tire 1 with a cushioning function, and is typically made of flexible rubber having a level of fatigue resistance.

The pneumatic tire 1 may include a side rib 12 provided between the ground contact end E1, E2 of the tread 10 and the portion of the sidewall 11 that protrudes furthest outward in the tire axial direction. The side rib 12 protrudes outward in the tire axial direction and is provided in an annular shape along the tire circumferential direction. The portions of the pneumatic tire 1 from the ground contact ends E1 and E2 or from regions close to the ground contact ends E1 and E2, to the left and right side ribs 12, are also referred to as buttress regions.

Furthermore, the sidewall 11 is generally provided with letters, numbers, symbols, and the like referred to as serial information. The serial information includes, for example, a size code, a manufacturing date (manufacturing year/week), and a manufacturing location (manufacturing plant code).

The bead 13 is a portion placed inward of the sidewall 11 in the tire radial direction and fixed to a rim of a wheel. The bead 13 includes a bead core 16 and a bead filler 17. The bead core 16 is an annular member composed of a steel bead wire and extending over the entire circumference in the tire circumferential direction and is embedded in the bead 13. The bead filler 17 is an annular hard rubber member with a tapered tip shape that extends outward in the tire radial direction, the rubber member extending over the entire circumference in the tire circumferential direction.

The carcass 14 extends between a pair of beads 13 and secured by being folded around the bead core 16. The carcass 14 includes a carcass cord made of organic fibers and a topping rubber. The carcass cord is placed at substantially right angles to the tire circumferential direction (e.g., between 80° and) 90°. Examples of organic fibers used for the carcass cord include polyester fiber, rayon fiber, aramid fiber, or nylon fiber.

The inner liner 15 covers an inner surface of the tire between the pair of beads 13. The inner liner 15 is composed of air permeation resistant rubber and has a function of maintaining the air pressure of the pneumatic tire 1.

Furthermore, the pneumatic tire 1 further includes a belt 18 disposed outward of the carcass 14 in the tire radial direction and a cap ply 19 covering the outer side of the belt 18 in the tire radial direction. The cap ply 19 has a function of reinforcing the belt 18. The number of cap plies 19 may be one or two, or two or more.

The belt 18 is placed outward of a top portion of the carcass 14 in the tire radial direction and is superimposed on the outer peripheral surface of the carcass 14. The belt 18 is formed of a belt ply made by coating, with a rubber, cords arranged in a direction inclined relative to the tire circumferential direction. The material of the belt ply cord is not particularly limited, and examples thereof include organic fibers such as polyester, rayon, nylon, or aramid, or metals such as steel.

In the present embodiment, the belt 18 includes two belt plies 18A and 18B. The cords constituting the two belt plies 18A and 18B are arranged to intersect each other between the two belt plies 18A and 18B.

Here, the cords constituting the two belt plies 18A and 18B have an angle (belt angle) of preferably between 22° and 29°, more preferably between 23° and 28°, to the tire circumferential direction. When the cord angle to the tire circumferential direction is designed within the above range, the constraint force acting on the outer side of the belt 18 in the tire axial direction increases such that the shape of the ground contact surface of the tread 10 becomes curved, allowing the rectangularity of the ground contact surface of the tread 10 to be reliably controlled within a range of between 0.6 and 0.7. As a result, noise performance can be improved, as described later.

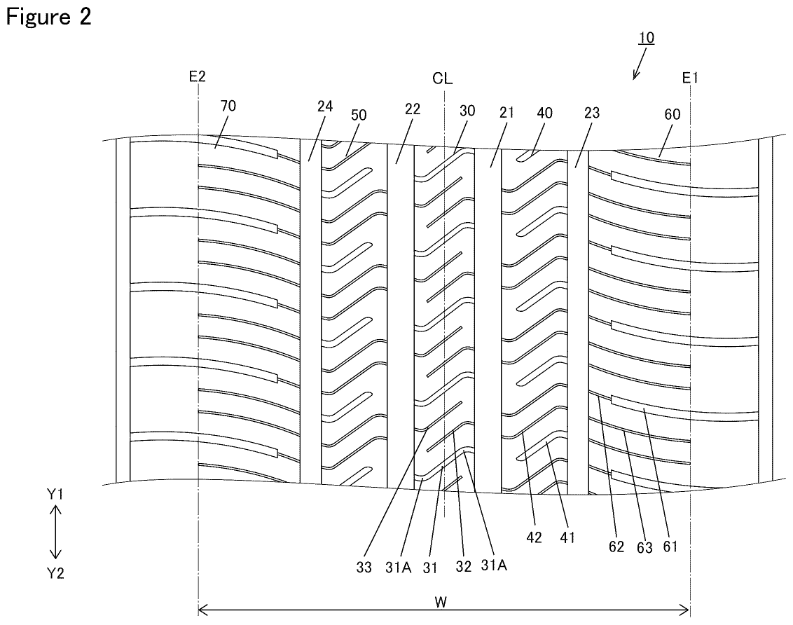

Hereinafter, with reference to FIG. 2, the tread pattern of the pneumatic tire 1 will be described. FIG. 2 is a plan view of the pneumatic tire 1 (tread 10).

The tread 10 includes the pair of center main grooves 21 and 22 and the pair of shoulder main grooves 23 and 24 formed outward of the center main grooves 21 and 22 in the tire axial direction. The center main groove 21 and the shoulder main groove 23 are formed in a region on a ground contact end E1 side of the tire equator CL, and the center main groove 22 and the shoulder main groove 24 are formed in a region on a ground contact end E2 side of the tire equator CL.

The center main grooves 21 and 22 and the shoulder main grooves 23 and 24 are formed straight along the tire circumferential direction without bending in the tire axial direction. With this configuration, water on the road surface is likely to enter the interiors of the center main grooves 21 and 22 and the shoulder main grooves 23 and 24, and drainage performance can be improved.

A sum of widths of four main grooves is preferably 20% or more of a length W along the tire axial direction from the ground contact end E1 to the ground contact end E2 (hereinafter referred to as a “ground contact width W”). With this configuration, snow or water is more likely to enter each main groove, and on-snow performance and drainage performance can be improved. The sum of widths of four main grooves is further preferably 25% or less of the ground contact width W. With this configuration, the air column resonance sound caused by the main grooves can be reduced, and the noise performance can be improved. Therefore, the sum of widths of four main grooves is, for example, preferably between 20% and 25% of the ground contact width W. In the present description, the width of the groove refers to the width on a profile surface along the ground contact surface of the tread 10 unless otherwise specified.

In the present embodiment, the shoulder main grooves 23 and 24 have a width smaller than that of the center main grooves 21 and 22. Because the shoulder main grooves 23 and 24 are arranged outward of the center main grooves 21 and 22 in the tire axial direction, the shape of the shoulder main grooves 23 and 24 significantly influences noise during travel. Therefore, reducing the width of the shoulder main grooves 23 and 24 compared to the center main grooves 21 and 22 reduces the volume of the shoulder main grooves 23 and 24 and reduces air column resonance sound caused by the shoulder main grooves 23 and 24. As a result, noise performance can be improved. A ratio of the width of the shoulder main grooves 23 and 24 to the width of the center main grooves 21 and 22 is, for example, between 75% and 90%.

The width of the center main grooves 21 and 22 is, for example, between 6 mm and 15 mm, and the width of the shoulder main grooves 23 and 24 is, for example, between 5 mm and 12 mm.

In addition, four main grooves preferably have a depth of between 6.8 mm and 7.2 mm. If the depth of the four main grooves is in the above range, air column resonance sound generated by the main grooves can be reduced while also improving the on-snow performance and drainage performance. As a result, the noise performance can be improved while also improving the on-snow and drainage performances. In the present description, the groove depth refers to a length along the tire radial direction from the profile surface along the ground contact surface of the tread 10 to the deepest portion of the groove unless otherwise specified.

In the present embodiment, the shoulder main grooves 23 and 24 are formed to have a smaller depth than the center main grooves 21 and 22. As described above, the shape of the shoulder main grooves 23 and 24 significantly influences noise during travel. Therefore, reducing the depth of the shoulder main grooves 23 and 24 compared to the center main grooves 21 and 22 reduces the volume of the shoulder main grooves 23 and 24 and reduces the air column resonance sound caused by the shoulder main grooves 23 and 24. As a result, noise performance can be improved. A ratio of the depth of the shoulder main grooves 23 and 24 to the depth of the center main grooves 21 and 22 is, for example, between 50% and 97%, or may be between 50% and 95%.

In the present embodiment, the center main grooves 21 and 22 have the same shape, and the shoulder main grooves 23 and 24 have the same shape. In other words, the cross-sectional area of the center main groove 21 is equal to the cross-sectional area of the center main groove 22, and the cross-sectional area of the shoulder main groove 23 is equal to the cross-sectional area of the shoulder main groove 24. Here, the cross-sectional area of each main groove refers to an area of a portion surrounded by the wall surface of the main groove and the profile surface along the ground contact surface of the tread 10, in the radial cross-section of the tire. In addition, the cross-sectional area of each main groove has a value measured on the radial cross-section of the tire when the unused tire is mounted to a specified rim, inflated to a specified internal pressure, and placed in an unloaded state.

The ratio of the groove cross-sectional area of the shoulder main groove 23 or 24 to the groove cross-sectional area of the center main groove 21 or 22 is, for example, preferably between 0.5 and 0.9, or more preferably between 0.6 and 0.8. With this configuration, noise performance can be further improved by further reducing the air column resonance sound caused by the shoulder main grooves 23 and 24, while still ensuring the rigidity of the tread 10.

Furthermore, at least one of the center main grooves 21 and 22 and shoulder main grooves 23 and 24 is typically provided with a wear indicator (not shown). The wear indicator is a protrusion located at the bottom of the groove, serving as a reference for checking the wear level of tread rubber.

The tread 10 includes the center land portion 30 partitioned by the center main grooves 21 and 22, the first middle land portion 40 partitioned by the center main groove 21 and the shoulder main groove 23, and the second middle land portion 50 partitioned by the center main groove 22 and the shoulder main groove 24. Furthermore, the tread 10 includes the first shoulder land portion 60 placed opposite the first middle land portion 40 via the shoulder main groove 23 in the tire axial direction, and the second shoulder land portion 70 placed opposite the second middle land portion 50 via the shoulder main groove 24 in the tire axial direction. The center land portion 30, the first middle land portion 40, the second middle land portion 50, the first shoulder land portion 60, and the second shoulder land portion 70 are formed continuously in the tire circumferential direction.

As described above, the mounting direction of the pneumatic tire 1 to the vehicle is not limited, and the pneumatic tire is a point-symmetrical tire in which the tread pattern and the shape of the tire side surface remain unchanged regardless of the direction in which the pneumatic tire is mounted to the vehicle. Therefore, the shape of the second middle land portion 50 is the same as the shape of first middle land portion 40 rotated about any point on the tire equator CL, and the shape of the second shoulder land portion 70 is the same as the shape of the first shoulder land portion 60 rotated about any point on the tire equator CL. Therefore, in the following, the center land portion 30, the first middle land portion 40 and the first shoulder land portion 60 will be described, and the description of the second middle land portion 50 and the second shoulder land portion 70 will be omitted. In the following, as shown in FIG. 2, a first direction in the tire circumferential direction may be referred to as “Y1 direction” and a second direction may be referred to as “Y2 direction”.

### Center Land Portion 30

The center land portion 30 is formed on the tire equator CL. In the present embodiment, a middle portion of the center land portion 30 in the tire axial direction is placed on the tire equator CL. A width of the center land portion 30 is, for example, between 5% and 30% of the ground contact width W.

In the center land portion 30, center lateral grooves 31 communicating with the center main grooves 21 and 22, respectively, are formed at intervals in the tire circumferential direction. The center lateral grooves 31 may, for example, have a substantially uniform groove width over a length direction. The groove width of the center lateral grooves 31 is, for example, between 2 mm and 5 mm.

Each center lateral groove 31 has a substantially S-shape in planar view of the center land portion 30. Specifically, the center lateral groove 31 includes an angled portion 31A curved to protrude on one side in the tire circumferential direction, at a position of each of opposite ends of the center lateral groove 31 in the tire circumferential direction, in planar view of the center land portion 30. When the center lateral groove 31 includes the angled portions 31A, strain applied to the center lateral groove 31 during travel is distributed, and ground contact pressure of the center land portion 30 is distributed. As a result, for example, steering stability improves. In the present embodiment, the angled portions 31A are formed on opposite sides, respectively, of the center lateral groove 31 in the length direction.

Two types of center sipes 32 and 33 are formed in the center land portion 30. The center sipe 32 communicates with the center main groove 21, is formed inside the center land portion 30, and does not communicate with the center main groove 22. In contrast, the center sipe 33 communicates with the center main groove 22, is formed inside the center land portion 30, and does not communicate with the center main groove 21. This ensures the rigidity of the center land portion 30, and readily improves, for example, steering stability. In the present description, a sipe refers to a groove with a groove width of 1.5 mm or less.

Each of the center sipes 32 and 33 is formed between two center lateral grooves 31 that are adjacent to each other in the tire circumferential direction. That is, lateral grooves and sipes are formed repeatedly in the order of the center lateral groove 31, center sipe 32, and center sipe 33 along the Y1 direction in the tire circumferential direction.

In the present embodiment, an end of the center sipe 32 on a center main groove 21 side and an end of the center sipe 33 on a center main groove 22 side are arranged at a position that overlaps the ends in the tire circumferential direction with the center sipe 32 extending inward in the tire axial direction, along a direction inclined along a Y2 direction relative to the tire axial direction, excluding the vicinity of a portion of the center sipe 32 that communicates with the center main groove 21. The center sipe 33 extends inward in the tire axial direction along a direction inclined along the Y1 direction relative to the tire axial direction, excluding the vicinity of a portion of the center sipe 33 that communicates with the center main groove 22. An inclination angle of the center sipe 32 to the tire axial direction is the same as an inclination angle of the center sipe 33 to the tire axial direction. The inclination angles of the center sipes 32 and 33 to the tire axial direction is, for example, between 10° and 70°, or may be between 20° and 60°.

The center sipes 32 and 33 have the same length in the tire axial direction. The length of the center sipes 32 and 33 in the tire axial direction is, for example, between 50% and 90% of the width of the center land portion 30. In the present description, the length of the sipe (including the groove) in the tire axial direction refers to the length along the tire axial direction between an inner end of the sipe (groove) in the tire axial direction and an outer end of the sipe (groove) in the tire axial direction.

### First Middle Land Portion 40

The first middle land portion 40 is placed opposite the center land portion 30 via the center main groove 21 in the tire axial direction and placed opposite the first shoulder land portion 60 via the shoulder main groove 23 in the tire axial direction. A width of the first middle land portion 40 is, for example, between 5% and 30% of the ground contact width W. In the present embodiment, the width of the first middle land portion 40 is larger than the width of the center land portion 30.

In the first middle land portion 40, middle lateral grooves 41 are formed at intervals in the tire circumferential direction. Each middle lateral groove 41 communicates with the shoulder main groove 23 and is formed inside the first middle land portion 40 and does not communicate with the center main groove 21. The middle lateral groove 41 has a substantially uniform groove width, for example, over the length direction. The groove width of the middle lateral groove 41 is, for example, between 2 mm and 5 mm.

The middle lateral groove 41 extends inward in the tire axial direction along a direction inclined along the Y2 direction relative to the tire axial direction, excluding the vicinity of a portion of the middle lateral groove 41 that communicates with the shoulder main groove 23. An inclination angle of the middle lateral groove 41 to the tire axial direction is, for example, between 10° and 70°, or may be between 20° and 60°. In the present embodiment, the inclination angle of the middle lateral grooves 41 to the tire axial direction is equal to the inclination angle of the center sipes 32 and 33 to the tire axial direction, the center sipes 32 and 33 being formed in the center land portion 30.

As described above, the middle lateral groove 41 does not communicate with the center main groove 21. Consequently, the rigidity of the first middle land portion 40 on an inner side in the tire axial direction improves. As a result, for example, steering stability improves. The length of the first middle land portion 40 in the tire axial direction is, for example, between 50% and 90% of the width of the first middle land portion 40.

In the first middle land portion 40, a middle sipe 42 is formed to communicate with each of the center main groove 21 and the shoulder main groove 23. Two middle sipes 42 are formed between two middle lateral grooves 41 that are adjacent to each other in the tire circumferential direction. That is, lateral grooves and sipes are formed repeatedly in the order of the middle lateral groove 41, middle sipe 42, and middle sipe 42 along the Y1 direction in the tire circumferential direction. The middle sipe 42 may communicate with just one of the center main groove 21 or the shoulder main groove 23.

The middle sipe 42 has a substantial S-shape in planar view of the first middle land portion 40 in the same manner as the center lateral groove 31. Specifically, the middle sipe 42 has an angled portion curved to protrude on one side in the tire circumferential direction of positions of opposite ends of the middle sipe 42 in the tire circumferential direction in planar view of the first middle land portion 40. When the middle sipe 42 has the above shape, strain applied to the middle sipe 42 during travel is distributed, and ground contact pressure of the first middle land portion 40 is distributed. As a result, for example, the steering stability improves. In the present embodiment, the angled portions are formed on opposite sides, respectively, of the middle sipe 42 in the length direction.

### First Shoulder Land Portion 60

The first shoulder land portion 60 is located opposite the first middle land portion 40 via the shoulder main groove 23 in the tire axial direction. A width of the ground contact surface of the first shoulder land portion 60 is, for example, between 10% and 30% of the ground contact width W.

In the first shoulder land portion 60, shoulder lateral grooves 61 extending in a direction intersecting the shoulder main groove 23 are formed at intervals in the tire circumferential direction. The shoulder lateral grooves 61 are formed outward in the tire axial direction beyond the ground contact end E1. The shoulder lateral grooves 61 have, for example, a substantially uniform groove width over the length direction. The groove width of each shoulder lateral groove 61 may be larger than the groove width of each of the center lateral groove 31 and the middle lateral groove 41 and may be, for example, between 2.5 mm and 6 mm.

The shoulder lateral groove 61 is formed to be inclined along the Y1 direction as it extends inward in the tire axial direction. The shoulder lateral grooves 61 communicate with the shoulder main groove 23 through communication sipes 62. This increases a grip force with a road surface during travel on the snow-covered road surface and improves the on-snow performance.

In addition, the shoulder lateral groove 61 significantly influences pattern noise generated when the tread 10 contacts the road surface. Specifically, as the volume of the shoulder lateral groove 61 in contact with the road surface increases, the pattern noise increases, and noise performance degrades. Providing the communication of the shoulder lateral grooves 61 with the shoulder main groove 23 through the communication sipes 62 as described above can reduce the volume of each shoulder lateral groove 61 in contact with the road surface and in turn reduce the pattern noise.

The length of each communication sipe 62 in the tire axial direction is, for example, between 5% and 30% of the width of the ground contact surface of the first shoulder land portion 60. The communication sipe 62 may have a substantially uniform depth over the length direction or have a region in which the depth varies locally.

In the first shoulder land portion 60, shoulder sipes 63 communicating with the shoulder main groove 23 are formed. Two of the shoulder sipes 63 are formed between two shoulder lateral grooves 61 that are adjacent to each other in the tire circumferential direction. In other words, grooves and sipes are repeatedly formed in the order of the shoulder lateral groove 61, shoulder sipe 63, and shoulder sipe 63 along the Y1 direction in the tire circumferential direction.

The shoulder sipe 63 is formed outward in the tire axial direction beyond the ground contact end E1 and shorter than the shoulder lateral groove 61. The shoulder sipe 63 is formed to be inclined along the Y1 direction as it extends inward in the tire axial direction in the same manner as the shoulder lateral groove 61.

As described above, in the tread 10, multiple sipes are formed, including the center sipes 32 and 33, middle sipes 42, communication sipes 62, and shoulder sipes 63. Here, in a length of each sipe in a longitudinal direction, a length of a component along the tire axial direction is defined as a sipe lateral length. Furthermore, the length of the sipe in the longitudinal direction refers to a straight line connecting opposite ends of the sipe in the tire axial direction. That is, the sipe lateral length refers to the length of the component along the tire axial direction in the straight line connecting the opposite ends of the sipe in the tire axial direction.

In the present embodiment, a total value of sipe lateral lengths of all sipes in the ground contact surface of the tread 10, that is, a region surrounded by the ground contact ends E1 and E2 is divided by an area of the entire ground contact surface of the tread 10, to obtain a value (hereinafter referred to as a “lateral sipe density”) of 0.050 m/mm² or more. As the length of the component along the tire axial direction of the sipe increases, the grip force with the road surface increases during travel on the snow-covered surface, and the on-snow performance improves. As will be shown in the results of examples below, when the sipes are formed so that the lateral sipe density is 0.050 m/mm² or more, a rectangularity of the ground contact surface of the tread 10 is between 0.6 and 0.7, and the shape of the ground contact surface of the tread 10 is close to an elliptical shape. With this configuration also, the on-snow performance can be ensured.

The lateral sipe density may be 0.050 m/mm² or more, or preferably 0.052 m/mm² or more, or further preferably 0.054 m/mm² or more. As the value of the lateral sipe density increases, the grip force with the road surface increases during travel on the snow-covered surface, and the on-snow performance improves. Furthermore, to ensure the rigidity of the tread 10 and improve steering stability on a dry road surface, an upper limit of lateral sipe density is, for example, 0.060 m/mm².

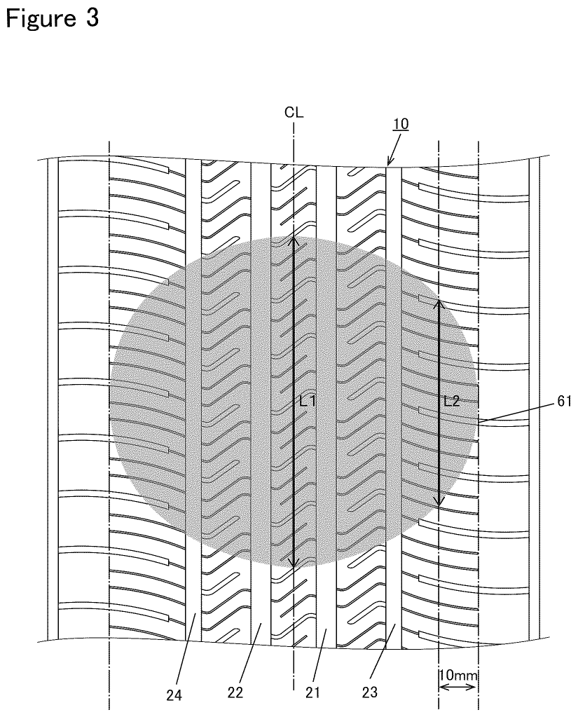

Next, the shape of the ground contact surface of the tread 10 will be described in detail with reference further to FIG. 3. FIG. 3 is a view schematically showing the shape of the ground contact surface of the tread 10.

As shown in FIG. 3, the ground contact surface of the tread 10 of the present embodiment has a comparatively short ground contact length (L2) in the vicinity of the ground contact end compared to the ground contact length (L1) on the tire equator CL, the ground contact surface having a shape close to an elliptical shape. Here, the ground contact length (L1) refers to a length along the tire circumferential direction on the tire equator CL of the ground contact surface, when an unused pneumatic tire is mounted to a specified rim and filled with air to obtain a predetermined internal pressure, and a load corresponding to 88% of a specified load is applied. The ground contact length (L2) is a length of the ground contact surface along the tire circumferential direction at a position of 10 mm inside the tire axial direction from opposite ends of the ground contact surface in the tire axial direction, obtained under the above measurement conditions. The predetermined internal pressure under the above measurement conditions is 200 kPa when a tire aspect ratio is 60% or more, and 220 kPa when the aspect ratio is less than 60%. Furthermore, in a tire marked as Extra Load, the predetermined internal pressure under the above measurement conditions is 240 kPa when the aspect ratio is 60% or more, and 260 kPa when the aspect ratio is less than 60%.

In the present description, L2/L1 is defined as the rectangularity of the ground contact surface of the tread 10. In the present embodiment, the ground contact length (L2) is substantially the same length on the left and right sides of the tread 10. As described above, as the rectangularity decreases, the shape of the ground contact surface of the tread 10 is closer to the elliptical shape. Therefore, as the rectangularity decreases, the frequency of the air column resonance sound generated in the center main grooves 21 and 22 and the shoulder main grooves 23 and 24 is distributed. As a result, the noise caused by the air column resonance sound is reduced, and the noise performance is improved.

Furthermore, as the rectangularity decreases, the ground contact surface on the outer side in the tire axial direction is reduced, with the result that the volume of the shoulder lateral groove 61 that contacts the road surface also decreases. As a result, the pattern noise can be reduced. Also, as the rectangularity decreases, the ground contact pressure is more likely to be distributed. Therefore, striking noise when the tread 10 hits the road surface is reduced, and noise performance is improved.

In addition, during travel, water on the road surface tends to be dispersed laterally along the contour of the ground contact surface of the tread 10. Therefore, as the rectangularity decreases, water from the road surface is more easily dispersed laterally, thereby improving drainage performance.

In contrast, if the rectangularity decreases, snow will less readily enter the main groove or lateral groove, and the on-snow performance is likely to degrade. In the present embodiment, however, the sipes are formed so that the lateral sipe density is 0.050 m/mm² or more as described above. Consequently, the grip force with the road surface is improved during travel on the snow-covered road surface, and on-snow performance is ensured even when the rectangularity is reduced.

From the perspective of improving noise performance while ensuring on-snow performance, the rectangularity of the ground contact surface of the tread 10 should be between 0.60 and 0.70, preferably between 0.62. The rectangularity of the ground contact surface of the tread 10 can be controlled, for example, by the angle (belt angle) of the cords of the belt plies 18A and 18B constituting the belt 18 with respect to the tire circumferential direction. As the belt angle increases, the constraint force acting on the outer side in the tire axial direction increases, and the rectangularity decreases. The method for controlling the rectangularity of the ground contact surface of the tread 10 is not limited to changing the belt angle, and may include, for example, changing arrangement or the like of the cap ply 19 or an edge ply (not shown) that reinforces the belt 18.

### EXAMPLE

Hereinafter, the present disclosure will be further described with respect to experimental examples, but the present disclosure is not limited to these experimental examples.

### Example 1

A pneumatic tire 1 (tire size: 235/65R17 104H) with the tread pattern shown in FIG. 2 was produced. This pneumatic tire 1 was with center main grooves 21 and 22 having a groove width of 10.7 mm; center main grooves 21 and 22 having a depth of 7.0 mm; shoulder main grooves 23 and 24 having a groove width of 8.4 mm; shoulder main grooves 23 and 24 having a depth of 6.8 mm; and the groove cross-sectional area of the center main grooves 21 and 22 and the groove cross-sectional area per groove in the shoulder main grooves 23 and 24 having the values shown in Table 1. The lateral sipe density of the tread 10 in Example 1 was calculated to be 0.055 m/mm².

Further, the belt 18 was formed by two belt plies 18A and 18B, and each belt angle was set to 24°. Then, the produced pneumatic tire 1 was mounted to a specified rim, the internal pressure of the tire was set to 260 kPa, and the load was 520 kg. In this case, the rectangularity of the ground contact surface of the tread 10 was 0.60.

### Examples 2 and 3

Pneumatic tires were produced in the same manner as in Example 1, except that belt angles were adjusted to set rectangularity ratios of ground contact surfaces of treads 10 to 0.62 and 0.65, respectively.

### Example 4

A pneumatic tire was produced in the same manner as in Example 1, except that based on the tread pattern shown in FIG. 2, the length of the sipes was shortened compared to the tread pattern shown in FIG. 2, and the lateral sipe density was set to 0.052 m/mm².

### Examples 5 and 6

Pneumatic tires were produced in the same manner as in Example 4, except that belt angles were adjusted to set rectangularity ratios of ground contact surfaces of treads 10 to 0.62 and 0.65, respectively.

### Comparative Examples 1 to 6

Based on the tread pattern in FIG. 2, the groove width of each main groove was adjusted so that the groove width and groove cross-sectional area indicated the values shown in Table 1 without changing the depths of the center main grooves 21 and 22 and shoulder main grooves 23 and 24. In addition, the length of each sipe and the belt angles were adjusted so that the lateral sipe density and rectangularity indicated the values shown in Table 1.

### Comparative Example 7

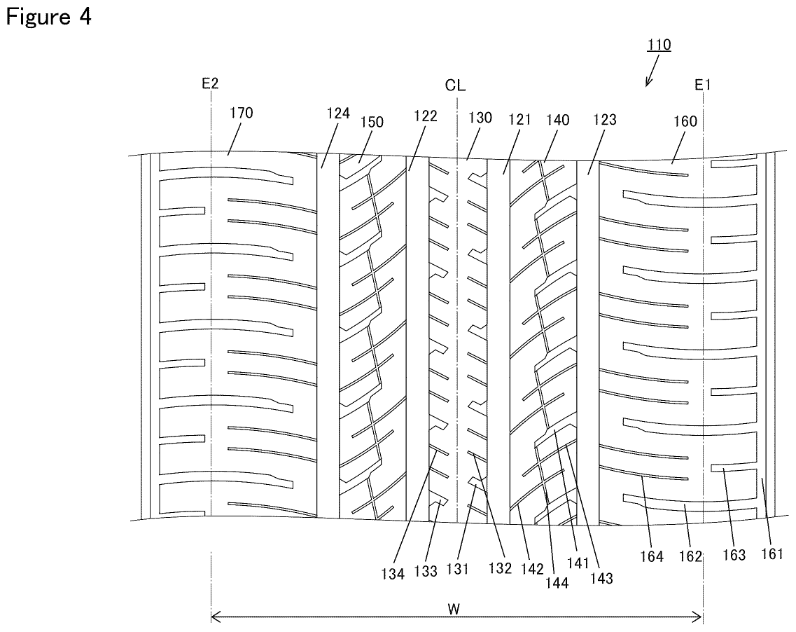

In place of the tread pattern shown in FIG. 2, the tread pattern shown in FIG. 4 was used. Hereinafter, the configuration of a tread 110 shown in FIG. 4 will be described.

As shown in FIG. 4, the tread 110 of Comparative Example 7 includes a pair of center main grooves 121 and 122 and a pair of shoulder main grooves 123 and 124 in the same manner as the tread 10 in FIG. 2. In this tire, the tread is produced so that the center main grooves 121 and 122 have a groove width of 8.8 mm; the center main grooves 121 and 122 have a depth of 7.3 mm; the shoulder main grooves 123 and 124 have a groove width of 8.6 mm; the shoulder main grooves 123 and 124 have a depth of 7.1 mm; and the groove cross-sectional area of the center main grooves 121 and 122 and the groove cross-sectional area per groove in the shoulder main grooves 123 and 124 indicate the values shown in Table 1. Consequently, as shown in Table 1, in the tread 110 shown in FIG. 4, the groove cross-sectional area of the center main grooves 121 and 122 is substantially equal to the groove cross-sectional area of the shoulder main grooves 123 and 124.

The tread 110 includes a center land portion 130, a first middle land portion 140, a second middle land portion 150, a first shoulder land portion 160, and a second shoulder land portion 170, as in the tread 10 in FIG. 2. The center land portion 130, the first middle land portion 140, the second middle land portion 150, the first shoulder land portion 160, and the second shoulder land portion 170 extend over a tire circumferential direction. In the tread 110 shown in FIG. 4, as in the tread 10 shown in FIG. 2, the second middle land portion 150 is reversed with respect to a tire equator CL, matching the shape of the first middle land portion 140, and the second shoulder land portion 170 is reversed with respect to the tire equator CL, matching the shape of the first shoulder land portion 160.

In the center land portion 130, there are formed center lateral grooves 131 and center sipes 132 communicating with the center main groove 121, and center lateral grooves 133 and center sipes 134 communicating with the center main groove 122.

In the first middle land portion 140, there are formed middle lateral grooves 141 communicating with the shoulder main groove 123, middle sipes 142 communicating with the center main groove 121, middle sipes 143 communicating with the shoulder main groove 123, and middle sipes 144 straddling the middle sipes 142 and 143.

In the first shoulder land portion 160, there are formed shoulder longitudinal grooves 161 extending along the tire circumferential direction, and shoulder lateral grooves 162 and 163 extending inward, in a tire axial direction, from the shoulder longitudinal grooves 161. None of the shoulder lateral grooves 162 and 163 communicate with the shoulder main groove 123, and the shoulder lateral grooves 162 are formed longer than the shoulder lateral grooves 163. In addition, in the first shoulder land portion 160, there are formed shoulder sipes 164 communicating with the shoulder main groove 123 and extending outward in the tire axial direction.

The lateral sipe density of the tread 110 in Comparative Example 7 shown in FIG. 4 was calculated to be 0.049 m/mm². In addition, the belt angle of a pneumatic tire 101 in Comparative Example 7 was set to 22°. Then, when this pneumatic tire was mounted to a specified rim, inflated to a tire internal pressure of 260 kPa, and loaded with 520 kg, the rectangularity of the ground contact surface of the tread 110 was 0.77.

### Evaluation of Noise Performance

Each of the pneumatic tires was mounted on a test vehicle, and a microphone was installed at a driver's ear position in the cabin, to measure sound pressure during travel on a dry flat asphalt road surface at 80 km/h. The evaluation result indicates a relative value when the evaluation result of Comparative Example 7 is set to 100, and a larger numerical value indicates a greater noise reduction effect and a superior noise performance.

### Evaluation of On-Snow Performance

Each of the produced pneumatic tires was mounted on a test vehicle, and a starting acceleration test for a section of 50 m was conducted from a stopped state on a snow-covered road surface, to calculate an average starting acceleration in a predetermined section. The evaluation result indicates a relative value when the acceleration calculation result in Comparative Example 7 is 100, and a greater numerical value indicates better on-snow performance.

Table 1 shows the evaluation results of the noise performance and on-snow performance of each pneumatic tire.

TABLE 1

| | Tread pattern | | | | | | | | | |
|---|---|---|---|---|---|---|---|---|---|---|
| | | | | Groove | Groove | | | | | |
| | | | | cross- | cross- | | | | | |
| | | | | sectional | sectional | | | | | |
| | | | | area of | area of | | | | | |
| | | Center | Shoulder | center | shoulder | | | | | |
| | | main | main | main | main | | Lateral | | Evaluation result | |
| | Base | groove | groove | groove | groove | | sipe | | Noise | On-snow |
| | tread | width | width | (S1) | (S2) | | density | Rectan | performance | performance |
| | pattern | [mm] | [mm] | [mm²] | [mm²] | S2/S1 | [m/mm²] | gularity | (index) | (index) |
| Example 1 | FIG. 2 | 10.7 | 8.4 | 64 | 45 | 0.70 | 0.055 | 0.60 | 106 | 103 |
| Example 2 | FIG. 2 | 10.7 | 8.4 | 64 | 45 | 0.70 | 0.055 | 0.62 | 106 | 103 |
| Example 3 | FIG. 2 | 10.7 | 8.4 | 64 | 45 | 0.70 | 0.055 | 0.65 | 106 | 103 |
| Example 4 | FIG. 2 | 10.7 | 8.4 | 64 | 45 | 0.70 | 0.052 | 0.60 | 106 | 100 |
| Example 5 | FIG. 2 | 10.7 | 8.4 | 64 | 45 | 0.70 | 0.052 | 0.62 | 106 | 100 |
| Example 6 | FIG. 2 | 10.7 | 8.4 | 64 | 45 | 0.70 | 0.052 | 0.65 | 106 | 100 |
| Comparative | FIG. 2 | 9.5 | 8.6 | 55 | 48 | 0.87 | 0.049 | 0.77 | 99 | 101 |
| Example 1 | | | | | | | | | | |
| Comparative | FIG. 2 | 10.2 | 8.6 | 60 | 46 | 0.77 | 0.049 | 0.77 | 98 | 102 |
| Example 2 | | | | | | | | | | |
| Comparative | FIG. 2 | 10.7 | 8.4 | 64 | 45 | 0.70 | 0.049 | 0.77 | 97 | 103 |
| Example 3 | | | | | | | | | | |
| Comparative | FIG. 2 | 10.7 | 8.4 | 64 | 45 | 0.70 | 0.049 | 0.62 | 106 | 97 |
| Example 4 | | | | | | | | | | |
| Comparative | FIG. 2 | 10.7 | 8.4 | 64 | 45 | 0.70 | 0.049 | 0.67 | 103 | 99 |
| Example 5 | | | | | | | | | | |
| Comparative | FIG. 2 | 10.7 | 8.4 | 64 | 45 | 0.70 | 0.049 | 0.72 | 100 | 101 |
| Example 6 | | | | | | | | | | |
| Comparative | FIG. 4 | 8.8 | 8.6 | 50 | 49 | 0.98 | 0.049 | 0.77 | 100 | 100 |
| Example 7 | | | | | | | | | | |

As shown in Table 1, the tires of the examples have improved noise performance while ensuring the on-snow performance compared to the tires of the comparative examples. In addition, the tires of Examples 1 to 3 having a higher lateral sipe density compared to the tires of Examples 4 to 6 have improved on-snow performance compared to the tires of Examples 4 to 6. It is presumed that this is because the grip force with the road surface has further improved during travel on the snow-covered road surface.

### REFERENCE SIGNS LIST

1 pneumatic tire
10 tread
11 sidewall
12 side rib
13 bead
14 carcass
15 inner liner
16 bead core
17 bead filler
18 belt
18A, 18B belt ply
19 cap ply
21, 22 center main groove
23, 24 shoulder main groove
30 center land portion
31 center lateral groove
31A angled portion
32, 33 center sipe
40 first middle land portion
41 middle lateral groove
42 middle sipe
50 second middle land portion
60 first shoulder land portion
61 shoulder lateral groove
62 communication sipe
63 shoulder sipe
70 second shoulder land portion
101 pneumatic tire
121, 122 center main groove
123, 124 shoulder main groove
130 center land portion
131, 133 center lateral groove
132, 134 center sipe
140 first middle land portion
141 middle lateral groove
142, 143, 144 middle sipe
150 second middle land portion
160 first shoulder land portion
161 shoulder longitudinal groove
162, 163 shoulder lateral groove
164 shoulder sipe
170 second shoulder land portion
CL tire equator
E1, E2 ground contact end

1. A pneumatic tire comprising a tread,
the tread including:
a pair of center main grooves;
a pair of shoulder main grooves placed outward of the center main grooves in a tire axial direction;
a center land portion partitioned by the pair of center main grooves;
a middle land portion partitioned by each of the center main grooves and each of the shoulder main grooves; and
a shoulder land portion placed outward of the shoulder main groove in the tire axial direction, wherein
multiple sipes are formed in the center land portion, the middle land portion, and the shoulder land portion, and
when, in lengths of the sipes in a longitudinal direction, lengths of components along the tire axial direction are defined as sipe lateral lengths, a total value of the sipe lateral lengths of all the sipes in a ground contact surface of the tread divided by an area of the entire ground contact surface of the tread is a value of 0.050 m/mm² or more, and
a rectangularity of the ground contact surface of the tread is 0.60 or more, and 0.70 or less.

2. The pneumatic tire according to claim 1, wherein a sum of widths of the pair of center main grooves and the pair of shoulder main grooves is 20% or more, and 25% or less, of a ground contact width of the tread, and
depths of the pair of center main grooves and the pair of shoulder main grooves are preferably 6.8 mm or more, and 7.2 mm or less.

3. The pneumatic tire according to claim 1, wherein a ratio of a groove width of the shoulder main groove to a groove width of the center main groove is 75% or more, and 90% or less.

4. The pneumatic tire according to claim 1, wherein a ratio of a groove cross-sectional area of the shoulder main groove to a groove cross-sectional area of the center main groove is 0.6 or more, and 0.8 or less.

5. The pneumatic tire according to claim 1, wherein the total value of the sipe lateral lengths of all the sipes is divided by the area of the entire ground contact surface of the tread, to obtain a value of 0.050 m/mm² or more, and 0.060 m/mm² or less.

6. The pneumatic tire according to claim 1, wherein the sipes provided in the center land portion communicate with one of the pair of center main grooves, and
the sipes provided in the middle land portion communicate with at least one of the center main groove and the shoulder main groove.

7. The pneumatic tire according to claim 1, wherein the center land portion is provided with a center lateral groove communicating with each of the pair of center main grooves, and
the center lateral groove includes an angled portion curved to protrude to one side, in a tire circumferential direction, of a position of each of opposite ends of the center lateral groove in the tire circumferential direction, in planar view of the center land portion.

8. The pneumatic tire according to claim 1, wherein the middle land portion is provided with a middle lateral groove that communicates with the shoulder main groove and that does not communicate with the center main groove.

9. The pneumatic tire according to claim 1, wherein a groove depth of the shoulder main groove is smaller than a groove depth of the center main groove.

10. The pneumatic tire according to claim 1, wherein the shoulder land portion is provided with a shoulder lateral groove extending outward in the tire axial direction, and
the shoulder lateral groove communicates with the shoulder main groove via each of the sipes.

11. The pneumatic tire according to claim 1, further comprising:
a carcass; and
a belt including at least one or more belt plies placed outward of the carcass in a tire radial direction, the belt ply including a cord disposed to be inclined in a tire circumferential direction, wherein an angle of the cord to the tire circumferential direction is 22° or more, and 29° or less.

12. The pneumatic tire according to claim 1, wherein the center land portion is provided with a center lateral groove communicating with each of the pair of center main grooves, and
the center lateral groove has a substantially S-shape in planar view of the center land portion.

13. The pneumatic tire according to claim 1, wherein the middle land portion is provided with a middle sipe communicating with each of the center main groove and the shoulder main groove, and
the middle sipe has a substantially S-shape in planar view of the middle land portion.

14. The pneumatic tire according to claim 1, wherein the middle land portion includes:
middle sipes communicating with each of the center main groove and the shoulder main groove; and
middle lateral grooves that communicate with the shoulder main groove and that do not communicate with the center main groove, and
two of the middle sipes are formed between two of the middle lateral grooves that are adjacent to each other in a tire circumferential direction.

15. The pneumatic tire according to claim 1, wherein the shoulder land portion includes:
shoulder lateral grooves extending outward in the tire axial direction; and
shoulder sipes communicating with the shoulder main groove and extending outward in the tire axial direction, and
two of the shoulder sipes are formed between two of the shoulder lateral grooves that are adjacent to each other in a tire circumferential direction.
